(19) United States
(12) Patent Application Publication
(10) Pub. No.: US 2014/0165172 A1
(43) Pub. Date: Jun. 12, 2014

(54) SYSTEM AND METHOD FOR AUTHENTICATION OF DEVICES FOR CONTROLLING NETWORK ACCESS

(71) Applicant: Rawstream, London (GB)

(72) Inventor: Brian Azzopardi, Birkirkara (MT)

(73) Assignee: Rawstream, London (GB)

(21) Appl. No.: 14/103,123

(22) Filed: Dec. 11, 2013

Related U.S. Application Data
(60) Provisional application No. 61/736,208, filed on Dec. 12, 2012.

(51) Int. Cl. H04L 29/06

(52) U.S. Cl. CPC H04L 63/08
USPC 726/7

(57) ABSTRACT

Described herein are methods and apparatus for providing a way for users to identify themselves to network resources (local and on the internet) in a manner that requires minimal user and IT administrator intervention. In certain embodiments, the disclosed technology provides a way to identify the user of a device, without requiring either an agent, or updating device settings. Thus, the disclosed technology removes the labor involved and makes it much quicker for new devices to be allowed to access network resources, for instance, in a school setting where students may want to bring their own devices, thus rendering it impractical for the school's IT department to update each and every device. In addition, students may not want to install agents or update the settings on their devices.

### BACKGROUND

A computer network provides a communication framework on which computers and other hardware components may communicate with each other and share information and data. Networks may include various systems for controlling access to the network, including authenticating the device that is trying to access the networks. Such approaches are typically used because software and services have policies defined by users or groups and they need to identify each user so they can apply the appropriate policy or configuration.

For example, networks may require that each device accessing the network be configured to use certain settings, such as settings to use specific servers, or else they require software agents to be installed on each device. Networks may control network access by requiring a device or users to register in a central directory, such as Lightweight Directory Access Protocol (LDAP) or Active Directory. Central directories act as a central location for network administration and security and provide user and device authentication before access to the network is granted. For example, a central directory may be used to authenticate a user's log in name and password and determine whether the user is a system administrator or a normal user.

### SUMMARY

Described herein are methods and apparatus for providing a way for users to identify themselves to network resources (local and on the internet) in a manner that requires minimal user and IT administrator intervention. In certain embodiments, the disclosed technology provides a way to identify the user of a device, without requiring either an agent, or updating device settings. Thus, the disclosed technology removes the labor involved and makes it much quicker for new devices to be allowed to access network resources, for instance, in a school setting where students may want to bring their own devices, thus rendering it impractical for the school's IT department to update each and every device. In addition, students may not want to install agents or update the settings on their devices.

The disclosed technology is not restricted to controlling access to the Internet and identifying users for the purposes of web filtering. Any resource that is either on the local network, or else on the Internet, can have access to it controlled via this disclosed technology.

For instance, access to a printer can be controlled via this manner, whereby any device attempting to access a network printer must first be authenticated.

In certain embodiments, devices are configured, either automatically or manually, to use an enhanced DNS server. In certain embodiments, whenever a device unknown to the DNS server sends the DNS server a DNS request, the DNS server redirects the device to a login page that presents a number of ways for the user using that device to identify themselves to the system. The ways of identifying the user may be local, or else utilize third-party systems like Google Apps or Active Directory. Once one or more of these systems have identified the user, the device is added to the list of known devices, and from then on, DNS requests from this device are processed according to business logic rules by the DNS server.

In certain embodiments, the disclosed technology includes a method including: receiving, from a device, via a network, a request; identifying, by a processor of a computing device, from the request, if a device is known, wherein if the device is unknown, (i) directing the device to a login server for authentication of the device; (ii) receiving, from the login server, information regarding the device, wherein the information includes at least one of device identity information or user identity information; (iii) storing, by the processor, the information regarding the device; requesting, by the processor, business logic rules associated with the request; receiving, from a business logic rules database, the business logic rules associated with the request; determining, by the processor, a response to the request according to the business logic rules associated with the request; and transmitting, by the processor, via the network, the response to the device.

In certain embodiments, the login server provides, via a graphical user interface, a menu of different authentication and identification options to the user. In certain embodiments, the business logic rules are functions of one or more variables selected from the group consisting of an agent identity, a device identity, a device type, a user identity, network conditions, a time, and a date. In certain embodiments, the business logic rules are one or more selected from the group consisting of Boolean statements, statistical functions, and mathematical functions.

In certain embodiments, directing the device to the login server for authentication of the device is via a dynamic network system. In certain embodiments, directing the device to the login server for authentication of the device is via a web protocol system.

In certain embodiments, the request is one or more selected from the group consisting of: a request for DNS lookup of a domain and an HTTP request for a web site. In certain embodiments, the response is one or more selected from the group consisting of: a DNS response to the DNS request that may direct the device to a requested resource or an alternative source, an HTTP response for a resource requested, an HTTP response that redirects the device to another resource or service, and an HTTP response that blocks access.

In certain embodiments, the disclosed technology includes a non-transitory computer-readable medium, wherein the computer readable medium stores instructions that, when executed by a processor, cause the processor to: receive, from a device, via a network, a request; identify, by a processor of a computing device, from the request, if a device is known, wherein if the device is unknown, (i) direct the device to a login server for authentication of the device; (ii) receive, from the login server, information regarding the device, wherein the information includes at least one of device identity information or user identity information; and (iii) store, by the processor, the information regarding the device; request, by the processor, business logic rules associated with the request; receive, from a business logic rules database, the business logic rules associated with the request; determine, by the processor, a response to the request according to the business logic rules associated with the request; and transmit, by the processor, via the network, the response to the device.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is an illustration describing an example method for authenticating a device in order to process a request from the device;

FIG. 2 is a flow chart of an example method for authentication a device by a server in order to process a request from the device;

FIG. 3 shows a block diagram of an exemplary cloud computing environment;

FIG. 4 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

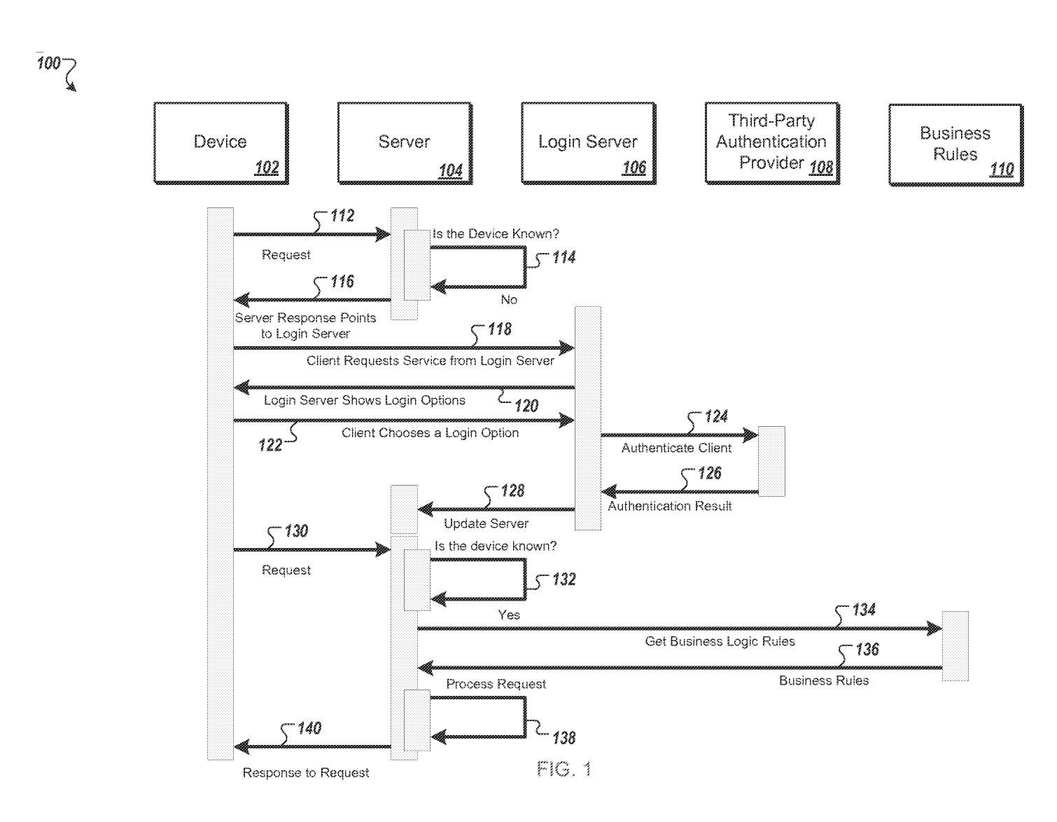

FIG. 1 illustrates a chart describing an example method 100 for authenticating a device in order to process a request from the device 102. In some implementations, a server 104 is installed on the network. In some implementations, the server 104 is an enhanced DNS server. In some implementations, the devices on the network are configured, manually or via automatic means, to use the DNS server as their DNS server. In some implementations, a router or other network element is configured to forward any received DNS requests to the DNS server.

In some implementations, the server 104 is an enhanced web proxy server. In some implementations, the devices on the network are configured, manually or via automatic means, to use the proxy server as their proxy server. In some implementations, a router or other network element is configured to forward any received requests to the proxy server.

In some implementations, the server is an application written in any general-purpose language such as C#, C++ or Java. The server may be run on any form of computing device, including but not limited to computers, laptops, mobile phones, smart phones, tablets, network routers and network interface cards. In some implementations, the server can integrate with the device to intercept the DNS requests in a number of ways. For example, in some implementations, on a PC computer or a laptop, the agent may listen on port 53, or any other port, for both UDP and TCP traffic. In some implementations, the server may intercept DNS requests at the OS kernel level or via an operating system interface that allows the interception of network traffic.

In some implementations, the server is implemented as a service that runs in the background. The server may collect information at regular intervals about its environment and the network it is running on. This information may include, but is not limited to, logged in users on the system, hardware and software information about the devices connected to the network, and network traffic.

In some implementations, the server 104 receives a request from the device 102(112). In some implementations, the request is a request for DNS lookup of a domain. In some implementations, the request is an HTTP request for a web site. Device 102 may be a personal computer, laptop, tablet computer, mobile phone, smart phone, tablet device, personal digital assistant, network device or any other computing device. In some implementations, the request is a DNS request. In some implementations, the request is a proxy request. The server 104 may determine whether the device 102 is known or unknown (114). If an unknown device requests service from the server 104, the server 104 redirects the device to a login server 106 for the device 102 or user to authenticate or identify themselves (116). In some implementations, the redirection to the login server 106 is done via DNS when the server 104 is a DNS server. In some implementations, the redirection to the login server is done via web protocols when the server 104 is a web proxy server.

In some implementations, the device 102 requests service from the login server 106 (118). In some implementations, the login server 106 presents a menu of different authentication and identification options. The login server 106 can be implemented in any number of ways including a standalone server, as part of another server, incorporated into a device such as a server or network component. The login server 106 may be an application written in any general-purpose language such as C#, C++ or Java.

In some implementations, the device 102 chooses a login option (122) from the menu of different authentication and identification options provided by the login server 106. In some implementations, the login server 106 will authenticate the device 102 with a third-party authentication provider 108 (124). The login options supported may include, but are not limited to, Google Apps, OAuth, LDAP, Active Directory, single-use codes, and proprietary authentication options.

In some implementations, the third-party authentication provider 108 provides an authentication result (126) to the login server 106. In some implementations, the login server 106 will communicate the results to the server 104 (128). In some implementations, this may include notifying the server 104 that the device 102 has been authenticated. In some implementations, this may include providing information to the server 104 so that the server may update the list of authenticated devices. In some implementations, once the third-party authentication provider 108 validates the request, the login server 106 communicates the relevant information, including any device or user information, to the server 104. After receiving validation, the server 104 may add the device to list of known devices.

In some implementations, after updating the list of known devices, the server 104 will receive the request from the device 102 again (130). In some implementations, the request may be included in the information provided by the login server 106 in step 128. In some implementations, the server 104 may store the request until it receives information in step 128.

In some implementations, the server 104 will verify the device 102 is known (132) by comparing the device 102 to the updated list of known devices. In some implementations, the server 104 will process request after step 128 without verifying the device is on the updated list of known devices.

In some implementations, the server 104 requests business logic rules 110 (134) in order to process the request. In some implementations, business logic rules 110 determine how requests are processed. The business logic rules 110 may use a number of different variables to determine how a request is processed including, but not limited to, device, device type, user, network conditions, time, and date information.

The business logic rules 110 may be in a multitude of forms including Boolean statements, or the product of statistical or mathematical functions. The rules 110 may include as inputs any information deemed relevant to how requests are processed, including agent IDs, device information, and other information collected by agents that is sent to the business logic server. The rules 110 can be used for a variety of purposes, including, but not limited to, monitoring of requests on a general, per-device or per-user basis, filtering of requests and redirection for the purposes for web-filtering and blocking.

The business logic rules 110 may be applied to a user or device, a group of users or devices, or all devices or users. In some implementations, the rules are static, that is, defined manually. In some implementations, the rules are generated automatically via machine learning, statistical techniques or else imported into the system from a third-party source such as a download site.

In some implementations, the business logic rules 110 are stored in a business logic rules database. The business logic rules database may be stored on a business logic rules server or on the server 104. In some implementations, the first time the server 104 is run, the server 104 may create one or more unique IDs such as a universally unique identifier (UUID) that are to be used when communicating with the business logic server.

In some implementations, the business logic rules 110 are provided to the server 104 (136). The server 104 may use the rules 110 to process the request (138). After processing the request, in some implementations, the server 104 responds to the request (140). In some implementations, the response is a DNS response to the DNS request that may direct the device to a requested resource or an alternative source. In some implementations, the response is an HTTP response for a resource requested. In some implementations, the response is an HTTP response that redirects the device to another resource or service. In some implementations, the response is an HTTP response that blocks access.

In some implementations, the server requires devices or users to re-authenticate for any reason including, but not limited to, elapsed time or user-defined policies.

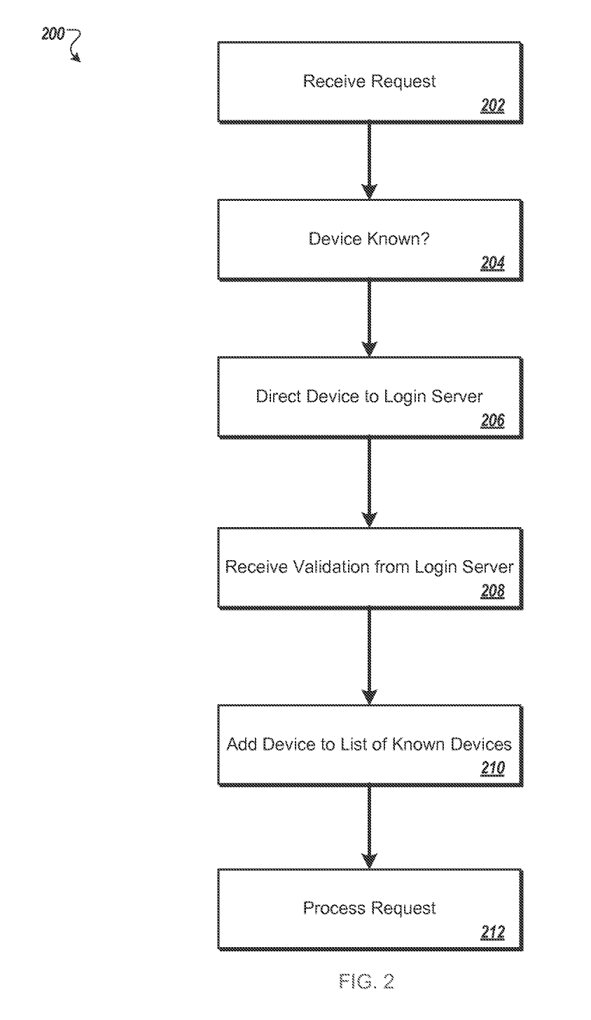

FIG. 2 is a flow chart of an example method 200 for authentication a device by a server in order to process a request from the device. In some implementations, the server, such as server 104 as described in FIG. 1, receives a request (202). The server may determine whether the device is known (204). In some implementations, the server directs the device to a login server (206). In some implementations, the server and the login server may be the same server.

In some implementations, the server receives validation from the login server (208). The validation confirms that the device is known or has been properly authenticated. Upon confirming the device is known, the server may add the device to a list of known devices (210). In some implementations, devices on the list of known devices do not need to be authenticated by the login server upon submitting a request to the server.

In some implementations, after the identity of the device has been validated, the request from the device is processed (212).

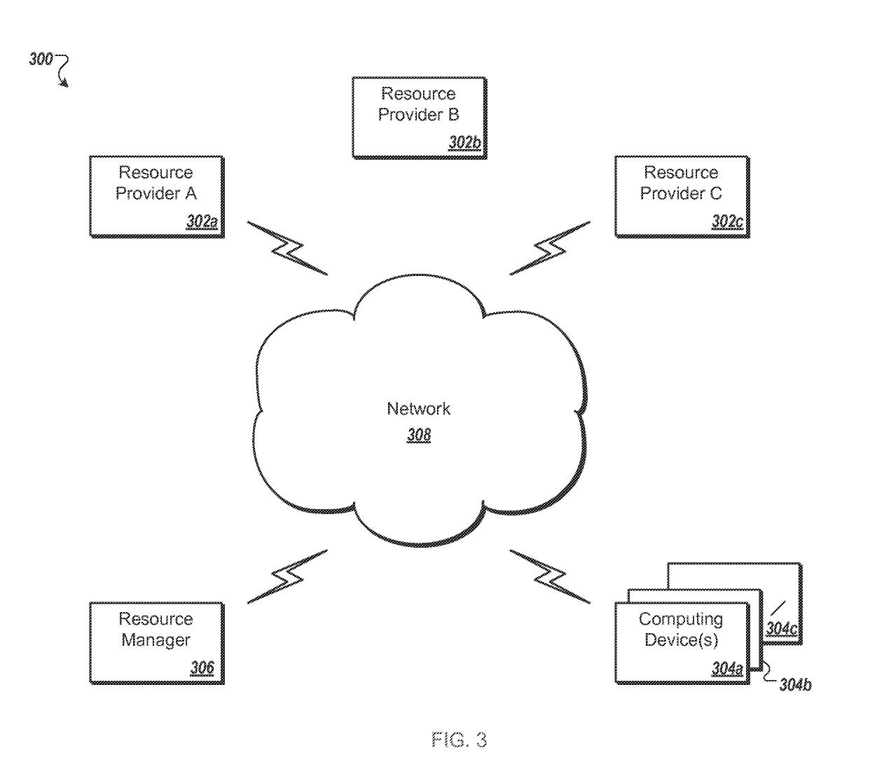

As shown in FIG. 3, an implementation of a network environment 300 for use authenticating a user and/or device is shown and described. In brief overview, referring now to FIG. 3, a block diagram of an exemplary cloud computing environment 300 is shown and described. The cloud computing environment 300 may include one or more resource providers 302a, 302b, 302c (collectively, 302). Each resource provider 302 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 302 may be connected to any other resource provider 302 in the cloud computing environment 300. In some implementations, the resource providers 302 may be connected over a computer network 308. Each resource provider 302 may be connected to one or more computing device 304a, 304b, 304c (collectively, 304), over the computer network 308.

The cloud computing environment 300 may include a resource manager 306. The resource manager 306 may be connected to the resource providers 302 and the computing devices 304 over the computer network 308. In some implementations, the resource manager 306 may facilitate the provision of computing resources by one or more resource providers 302 to one or more computing devices 304. The resource manager 306 may receive a request for a computing resource from a particular computing device 304. The resource manager 306 may identify one or more resource providers 302 capable of providing the computing resource requested by the computing device 304. The resource manager 306 may select a resource provider 302 to provide the computing resource. The resource manager 306 may facilitate a connection between the resource provider 302 and a particular computing device 304. In some implementations, the resource manager 306 may establish a connection between a particular resource provider 302 and a particular computing device 304. In some implementations, the resource manager 306 may redirect a particular computing device 304 to a particular resource provider 302 with the requested computing resource.

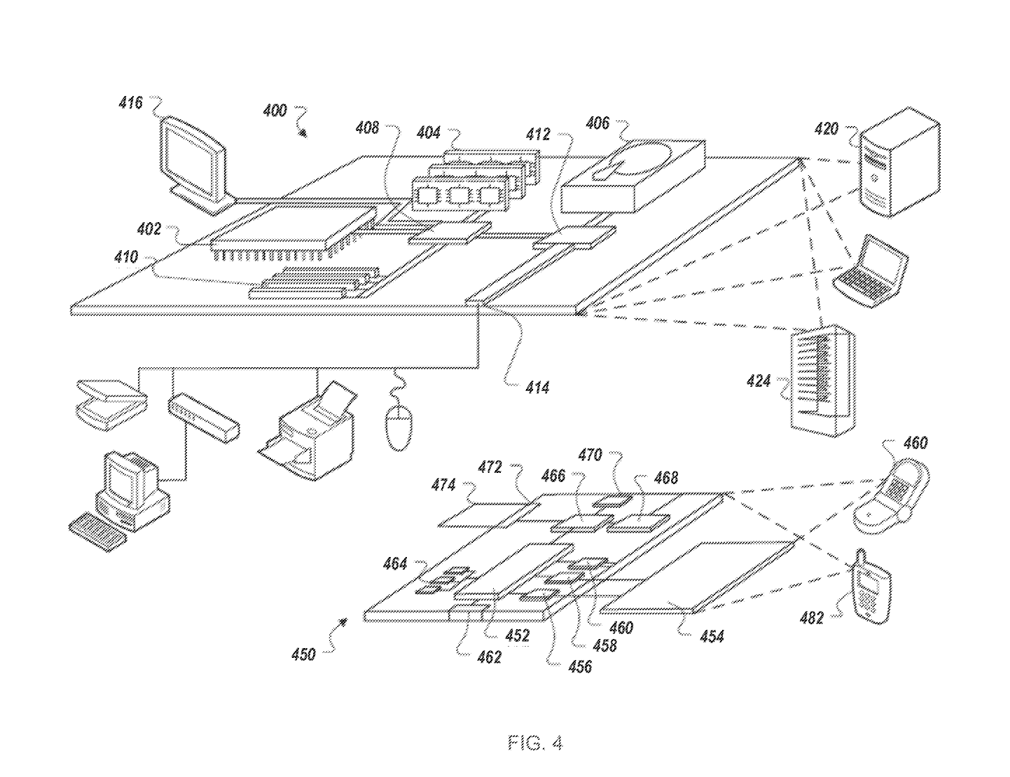

FIG. 4 shows an example of a computing device 400 and a mobile computing device 450 that can be used to implement the techniques described in this disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth®, Wi-Fi™, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for authenticating a user and/or device are provided. Having described certain implementations of methods and apparatus for supporting user and/or device authentication, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

What is claimed:

1. A method comprising:
receiving, from a device, via a network, a request;
identifying, by a processor of a computing device, from the request, if a device is known, wherein if the device is unknown,
(i) directing the device to a login server for authentication of the device;
(ii) receiving, from the login server, information regarding the device, wherein the information includes at least one of device identity information or user identity information; and
(iii) storing, by the processor, the information regarding the device;
requesting, by the processor, business logic rules associated with the request;
receiving, from a business logic rules database, the business logic rules associated with the request;
determining, by the processor, a response to the request according to the business logic rules associated with the request; and
transmitting, by the processor, via the network, the response to the device.

2. The method of claim 1, wherein the login server provides, via a graphical user interface, a menu of different authentication and identification options to the user.

3. The method of claim 1, wherein the business logic rules are functions of one or more variables selected from the group consisting of an agent identity, a device identity, a device type, a user identity, network conditions, a time, and a date.

4. The method of claim 1, wherein the business logic rules are one or more selected from the group consisting of Boolean statements, statistical functions, and mathematical functions.

5. The method of claim 1, wherein directing the device to the login server for authentication of the device is via a dynamic network system.

6. The method of claim 1, wherein directing the device to the login server for authentication of the device is via a web protocol system.

7. The method of claim 1, wherein the request is one or more selected from the group consisting of: a request for DNS lookup of a domain and an HTTP request for a web site.

8. The method of claim 1, wherein the response is one or more selected from the group consisting of: a DNS response to the DNS request that may direct the device to a requested resource or an alternative source, an HTTP response for a resource requested, an HTTP response that redirects the device to another resource or service, and an HTTP response that blocks access.

9. A non-transitory computer-readable medium, wherein the computer readable medium stores instructions that, when executed by a processor, cause the processor to:
receive, from a device, via a network, a request;
identify, by a processor of a computing device, from the request, if a device is known, wherein if the device is unknown,
(i) direct the device to a login server for authentication of the device;
(ii) receive, from the login server, information regarding the device, wherein the information includes at least one of device identity information or user identity information; and
(iii) store, by the processor, the information regarding the device;
request, by the processor, business logic rules associated with the request;
receive, from a business logic rules database, the business logic rules associated with the request;
determine, by the processor, a response to the request according to the business logic rules associated with the request; and
transmit, by the processor, via the network, the response to the device.

10. The computer-readable medium of claim 9, wherein the login server provides, via a graphical user interface, a menu of different authentication and identification options to the user.

11. The computer-readable medium of claim 9, wherein the business logic rules are functions of one or more variables selected from the group consisting of an agent identity, a device identity, a device type, a user identity, network conditions, a time, and a date.

12. The computer-readable medium of claim 9, wherein the business logic rules are one or more selected from the group consisting of Boolean statements, statistical functions, and mathematical functions.

13. The computer-readable medium of claim 9, wherein directing the device to the login server for authentication of the device is via a dynamic network system.

14. The computer-readable medium of claim 9, wherein directing the device to the login server for authentication of the device is via a web protocol system.

15. The non-transitory computer-readable medium of claim 9, wherein the request is one or more selected from the group consisting of: a request for DNS lookup of a domain and an HTTP request for a web site.

16. The method of claim 9, wherein the response is one or more selected from the group consisting of: a DNS response to the DNS request that may direct the device to a requested resource or an alternative source, an HTTP response for a resource requested, an HTTP response that redirects the device to another resource or service, and an HTTP response that blocks access.
